(19) United States
(12) Patent Application Publication
(10) Pub. No.: US 2026/0017119 A1
(43) Pub. Date: Jan. 15, 2026

(54) PROVISIONING A DATABASE MANAGEMENT PLATFORM IN A CLOUD COMPUTING ENVIRONMENT

(71) Applicant: FMR LLC, Boston, MA (US)

(72) Inventors: Jason A. Custodio, Manchester, NH (US); Raghu Kumar Thukral, Apex, NC (US); James Dooney, Somerville, MA (US); Victor Soohoo, Wellesley, MA (US)

(21) Appl. No.: 19/229,174

(22) Filed: Jun. 5, 2025

Related U.S. Application Data
(63) Continuation-in-part of application No. 18/772,509, filed on Jul. 15, 2024, now Pat. No. 12,353,430.

(51) Int. Cl. G06F 9/50; G06F 21/62

(52) U.S. Cl. CPC G06F 9/5077; G06F 21/6218

(57) ABSTRACT

Methods and apparatuses for provisioning a database management platform in a cloud computing environment include a server that reserves virtual computing resources in the cloud environment. The server provisions a database management platform using the reserved virtual computing resources. The database management platform includes primary and secondary database instances, a database observer instance, and a platform monitor agent. The server configures a database observer instance to monitor availability of database instances and to route traffic to other database instances. The server integrates the database management platform with an identity authentication service, monitors operational status of the database management platform using a monitoring service, and refreshes the reserved virtual computing resources in the database management platform using a rehydration service.

### RELATED APPLICATION(S)

This application is a continuation-in-part of U.S. patent application Ser. No. 18/772,509, filed Jul. 15, 2024, the entirety of which is incorporated herein by reference.

### TECHNICAL FIELD

This application relates generally to methods and apparatuses, including computer program products, for provisioning a database management platform in a cloud computing environment.

### BACKGROUND

Significant advances in computing and network technology over the last decade have contributed to the rise of cloud computing services and platforms. These cloud computing services enable enterprises to deploy and host their computing systems, applications, and related services (e.g., web servers, database servers, application servers) in a remote, shared, and often virtualized computing environment that does not need to be actively managed by the enterprise. Enterprises can thus take advantage of the immense computing power, memory storage, network bandwidth, and other highly scalable resources provided by such cloud computing services to provide a more flexible and efficient computing infrastructure for its employees and customers.

As a result, many enterprises have sought to automate deployment of key data processing applications and services—such as database management platforms like Azure Cloud Factory™ from Microsoft Corp.—to cloud environments. This endeavor has led to some technical challenges and obstacles. In one example, an enterprise may utilize application- or organization-specific database configurations or deployment pipelines for provisioning a database management platform in a cloud computing environment. Often, there are no tools available in the cloud computing platform to accomplish provisioning and deployment of the database management platform in an automated manner—for example, the cloud platform may not support deployment of pipelines or supporting infrastructure (e.g., virtual machines, endpoints, linked services) without appropriate owner or user approval. Therefore, manual, time-intensive and resource-intensive steps must be taken to both complete the initial provisioning and deployment, and to undertake ongoing maintenance and monitoring of the database management platform—which can lead to delays, errors, and lack of repeatability for such actions. In addition, the cloud computing platform may not have the out-of-the-box capability to integrate with other existing, on-premises enterprise systems (e.g., authentication, data security, application and network monitoring). Finally, depending upon the requirements of the locally-hosted computing systems, the cloud computing services may not be able to provide a level of service to meet service level agreement (SLA) requirements-for example, some systems may need resiliency options such as high-availability (HA) and failover/switchover protocols.

### SUMMARY

Therefore, what is needed are methods and systems for deploying, provisioning, and managing cloud-based database management platforms automatically, overcoming the lack of existing tools to accomplish such tasks. The techniques described herein advantageously enable a framework of provisioning, managing, monitoring, and rehydrating database management platforms and their associated virtual computing resources through centralized pipelining and automated continuous integration (CI)/continuous deployment (CD) processes, onboarding of such cloud computing resources to an identity authentication service, and allowing for resiliency, failover, and site swapping to deliver seamless and uninterrupted availability of critical data processing resources.

The invention, in one aspect, features a system for provisioning a database management platform in a cloud computing environment. The system includes a server computing device having a memory for storing computer-executable instructions and a processor that executes the computer-executable instructions. The server computing device reserves a plurality of virtual computing resources in a cloud computing environment coupled to the server computing device, the cloud computing environment comprising a plurality of regions. The server computing device provisions a database management platform in the cloud computing environment using the reserved virtual computing resources. The database management platform comprises (i) a primary database instance provisioned in a first region, (ii) a secondary database instance provisioned in a second region; (iii) a database observer instance provisioned in the first region coupled to the primary database instance and the secondary database instance; and (iv) a platform monitor agent provisioned in each of the first region and the second region, including attaching the primary database instance and the secondary database instance to physical disk drives. The server computing device configures the database observer instance to monitor availability of the primary database instance and to route traffic to the secondary database instance upon detecting that the primary database instance is unavailable. The server computing device integrates the database management platform with an identity authentication service provided by a first computing resource of the server computing device. The server computing device monitors operational status of the database management platform using a monitoring service provided by a second computing resource of the server computing device, the monitoring service coupled to the platform monitor agent in each region. The server computing device refreshes one or more of the reserved virtual computing resources in the database management platform using a rehydration service provided by a third computing resource of the server computing device.

The invention, in another aspect, features a computerized method of provisioning a database management platform in a cloud computing environment. A server computing device reserves a plurality of virtual computing resources in a cloud computing environment coupled to the server computing device, the cloud computing environment comprising a plurality of regions. The server computing device provisions a database management platform in the cloud computing environment using the reserved virtual computing resources. The database management platform comprises (i) a primary database instance provisioned in a first region, (ii) a secondary database instance provisioned in a second region; (iii) a database observer instance provisioned in the first region coupled to the primary database instance and the secondary database instance; and (iv) a platform monitor agent provisioned in each of the first region and the second region, including attaching the primary database instance and the secondary database instance to physical disk drives. The server computing device configures the database observer instance to monitor availability of the primary database instance and to route traffic to the secondary database instance upon detecting that the primary database instance is unavailable. The server computing device integrates the database management platform with an identity authentication service provided by a first computing resource of the server computing device. The server computing device monitors operational status of the database management platform using a monitoring service provided by a second computing resource of the server computing device, the monitoring service coupled to the platform monitor agent in each region. The server computing device refreshes one or more of the reserved virtual computing resources in the database management platform using a rehydration service provided by a third computing resource of the server computing device.

Any of the above aspects can include one or more of the following features. In some embodiments, the server computing device invokes an application programming interface to connect to the cloud computing environment and issue a request to reserve the plurality of virtual computing resources. In some embodiments, the database management platform further comprises (v) an event manager agent provisioned in each of the first region and the second region, where the event manager agent in the first region captures usage and performance metrics for the primary database instance and the event manager agent in the second region captures usage and performance metrics for the secondary database instance, and where each event manager agent is coupled to the monitoring service of the server computing device. In some embodiments, the database management platform further comprises (vi) a second database observer instance provisioned in a third region of the cloud computing environment, the second database observer instance coupled to the primary database instance and the secondary database instance. In some embodiments, the database management platform further comprises (vii) a replication agent provisioned in the first region, wherein the replication agent detects changes to data in the primary database instance and replicates the changes in the secondary database instance.

In some embodiments, integrating the database management platform with an identity authentication service comprises establishing a connection between the database management platform and the first computing resource of the server computing device, and coupling the primary database instance and the secondary database instance to the identity authentication service such that authentication of requests to access the database instances is performed by the identity authentication service. In some embodiments, the server computing device executes a build pipeline script to initiate reserving of the virtual computing resources and provisioning of the database management platform.

In some embodiments, refreshing the reserved virtual computing resources in the database management platform comprises deleting one or more reserved virtual computing resources in the database management platform, and provisioning one or more new virtual computing resources in the database management platform using updated resource templates. In some embodiments, the updated resource templates comprise an operating system image file or a security patch image file.

In some embodiments, the server computing device validates the provisioning of the database management system in the cloud computing environment upon completion of the provisioning step. In some embodiments, the server computing device transmits a validation report to a remote computing device upon validating the provisioning of the database management system.

The invention, in another aspect, features a system for updating computing resources deployed in database management platforms in a cloud computing environment. The system comprises a server computing device having a memory for storing computer-executable instructions and a processor that executes the computer-executable instructions. The server computing device captures a plurality of resource parameters corresponding to one or more virtual computing resources that support a database management platform deployed in a cloud computing environment coupled to the server computing device, the cloud computing environment comprising a plurality of regions. The server computing device determines one or more changes to the resource parameters based upon input from a client computing device coupled to the server computing device. The server computing device creates a parameter file based upon the determined changes to the resource parameters. The server computing device updates one or more of the virtual computing resources that support the database management platform in the cloud computing environment using data stored in the parameter file, including: deleting a first one or more of a plurality of existing disk group volumes associated with a primary database instance provisioned in a first region and a secondary database instance provisioned in a second region, resizing a second one or more of the plurality of existing disk group volumes associated with the primary database instance and the secondary database instance, adding one or more new disk group volumes associated with the primary database instance and the secondary database instance, and modifying one or more of a size, a throughput, a volume type, and a number of input/output operations per second of at least one of the disk group volumes currently available in the database management platform.

The invention, in another aspect, features a computerized method of updating computing resources deployed in database management platforms in a cloud computing environment. A server computing device captures a plurality of resource parameters corresponding to one or more virtual computing resources that support a database management platform deployed in a cloud computing environment coupled to the server computing device, the cloud computing environment comprising a plurality of regions. The server computing device determines one or more changes to the resource parameters based upon input from a client computing device coupled to the server computing device. The server computing device creates a parameter file based upon the determined changes to the resource parameters. The server computing device updates one or more of the virtual computing resources that support the database management platform in the cloud computing environment using data stored in the parameter file, including: deleting a first one or more of a plurality of existing disk group volumes associated with a primary database instance provisioned in a first region and a secondary database instance provisioned in a second region, resizing a second one or more of the plurality of existing disk group volumes associated with the primary database instance and the secondary database instance, adding one or more new disk group volumes associated with the primary database instance and the secondary database instance, and modifying one or more of a size, a throughput, a volume type, and a number of input/output operations per second of at least one of the disk group volumes currently available in the database management platform.

Any of the above aspects can include one or more of the following features. In some embodiments, a monitoring service provided by the server computing device captures the resource parameters by analyzing computing performance metrics and configuration attributes of the database management platform. In some embodiments, determining one or more changes to the resource parameters based upon input from the client computing device comprises comparing a resource parameter value captured by the server computing device to a corresponding resource parameter value contained in the input from the client computing device; and determining a difference between the resource parameter value captured by the server computing device and the corresponding resource parameter value contained in the input. In some embodiments, the server computing device modifies the resource parameter value captured by the server computing device to match the corresponding resource parameter value contained in the input. In some embodiments, creating the parameter file based upon the determined changes to the resource parameters comprises storing the modified resource parameter value in the parameter file and associating the modified resource parameter value with an identifier for the resource parameter.

In some embodiments, the database management platform further comprises a database observer instance provisioned in the first region coupled to the primary database instance and the secondary database instance. In some embodiments, the database observer instance monitors availability of the primary database instance and to route traffic to the secondary database instance upon detecting that the primary database instance is unavailable.

In some embodiments, an identity authentication service provided by the server computing device establishes a connection between the database management platform and the server computing device and couples the primary database instance and the secondary database instance to the identity authentication service such that authentication of requests to access the database instances is performed by the identity authentication service. In some embodiments, the server computing device executes a persistent update pipeline script to initiate capturing the plurality of resource parameters, determining changes to the resource parameters, creating the parameter file, and updating the virtual computing resources that support the database management platform.

In some embodiments, updating one or more of the virtual computing resources that support the database management platform in the cloud computing environment using data stored in the parameter file comprises deleting one or more of the virtual computing resources and provisioning one or more new virtual computing resources in the database management platform using updated resource templates. In some embodiments, the updated resource templates comprise an operating system image file or a security patch image file. In some embodiments, the server computing device validates the updating of the virtual computing resources that support the database management platform in the cloud computing environment upon completion of the modifying step. In some embodiments, updating of the virtual computing resources that support the database management platform in the cloud computing environment further comprises modifying one or more security groups configured to control access to disk drives coupled to the database instances of the database management platform.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for provisioning a database management platform in a cloud computing environment.

FIG. 2 is a flow diagram of a computerized method of provisioning a database management platform in a cloud computing environment.

FIG. 3 is a diagram of exemplary deployment automation pipeline workflows that can be executed by a provisioning module to deploy a database management platform.

FIG. 4 is a diagram of an exemplary workflow script that can be executed by a provisioning module for deployment of a database management platform.

FIG. 5 is a flow diagram of a computerized method of refreshing a virtual machine (VM) and associated elements in a cloud computing environment.

FIG. 6 is a flow diagram of a computerized method for capturing changes to resource parameter values for computing resources supporting a database management platform in a cloud computing environment.

FIG. 7 is a flow diagram of a computerized method of updating the computing resources supporting a database management platform in a cloud computing environment based upon changed resource parameter values.

### DETAILED DESCRIPTION

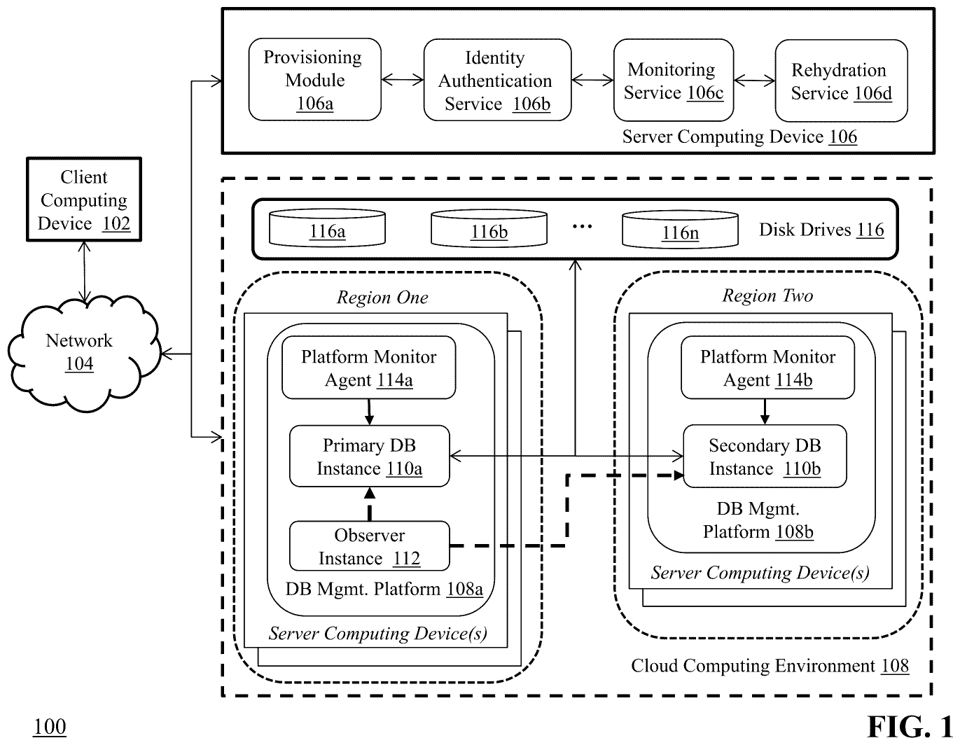

FIG. 1 is a block diagram of system 100 for provisioning a database management platform in a cloud computing environment. System 100 includes client computing device 102 that is coupled via communications network 104 to server computing device 106 and cloud computing environment 108. Server computing device 106 includes provisioning module 106a, identity authentication service 106b, monitoring service 106c, and rehydration service 106d. Cloud computing environment 108 includes a plurality of virtual machines (VMs) 108a, 108b executing on one or more server computing devices in different regions in cloud computing environment 108. VM 108a in Region One includes primary database (DB) instance 110a, observer instance 112, and platform monitor agent 114a. VM 108b in Region Two includes secondary DB instance 110b, and platform monitor agent 114b. Cloud computing environment 108 further includes one or more physical disk drives 116a-116n (collectively, 116).

Client computing device 102 connects to communications network 104 in order to communicate with server computing device 106 and cloud computing environment 108 to provide input and receive output relating to the process of provisioning a database management platform in a cloud computing environment as described herein. Client computing device 102 can be coupled to a display device (not shown). For example, client computing device 102 can provide a detailed graphical user interface (GUI) via the display device that presents output resulting from the methods and systems described herein, where the GUI is utilized by an operator to review and monitor database management platform status information provided by server computing device 102 and/or cloud computing environment 108.

Exemplary client devices 102 include but are not limited to desktop computers, laptop computers, tablets, mobile devices, smartphones, and internet appliances. It should be appreciated that other types of computing devices that can connect to the components of system 100 can be used without departing from the scope of invention. Although FIG. 1 depicts a single client computing device 102, it should be appreciated that system 100 can include any number of client devices.

Communication network 104 enables the other components of system 100 to communicate with each other in order to perform the process of provisioning a database management platform in a cloud computing environment as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of the system 100 to communicate with each other.

Server computing device 106 is a combination of hardware, including one or more special-purpose processors and one or more physical memory modules, and specialized software modules—such as modules 106a-106d—that are executed by a processor of server computing device 106, to receive data from other components of system 100, transmit data to other components of system 100, and perform functions for provisioning a database management platform in a cloud computing environment as described herein. In some embodiments, modules 106a-106d are specialized sets of computer software instructions programmed onto a dedicated processor in server computing device 106 and can include specifically designated memory locations and/or registers for executing the specialized computer software instructions. Further explanation of the specific processing performed by modules 106a-106d will be provided below.

Cloud computing environment 108 is a combination of hardware, including one or more special-purpose processors and one or more physical memory modules, and specialized software—such as virtual machines (VMs) 108a, 108b—that are executed by processor(s) of one or more server computing devices in cloud computing environment 108, to receive data from other components of system 100, transmit data to other components of system 100, and perform functions for provisioning a database management platform in a cloud computing environment as described herein. Each virtual machine 108a, 108b comprises a database (DB) instance 110a, 110b and a platform monitor agent 114a, 114b, while at least one virtual machine (in this example, VM 108a) includes an observer instance 112. In some embodiments, elements 110a-110b, 112, and 114a-114n comprise software modules such as one or more containers instantiated within virtual machines 108a, 108b that includes a plurality of files and configuration information (i.e., software code, environment variables, libraries, other dependencies, and the like). Cloud computing environment 108 can be configured to execute many instances of virtual machines 108a, 108b in isolation from each other, that access a single operating system (OS) kernel. In some embodiments, cloud computing environment 108 executes each VM 108a, 108b and/or the component elements 110a-110b, 112, and 114a-114b in a separate OS process, and constrains each element's access to physical resources (e.g., CPU, memory) of the corresponding server computing device so that a single virtual machine 108a-108b does not utilize all of the available physical resources. Upon execution, one or more server computing devices in cloud computing environment 108 executes application code and data stored in VMs 108a-108b for delivery, configuration, monitoring, presentation, and/or manipulation of the database management platform and associated data contained in, e.g., DB instances 110a, 110b by one or more endpoint devices. In one embodiment, cloud computing environment 108 is deployed using a commercially available cloud computing platform. As shown in FIG. 1, the resources of cloud computing environment 108 can be distributed into a plurality of regions which can be defined according to certain geographic and/or technical performance requirements. Each region can comprise one or more datacenters connected via a regional network that meets specific low-latency requirements. Inside each region, cloud computing environment 108 can be partitioned into one or more availability zones (AZ), which are physically separate locations used to achieve tolerance to, e.g., hardware failures, software failures, disruption in connectivity, unexpected events/disasters, and the like. Typically, the availability zones are connected using a high-performance network (e.g., round trip latency of less than two milliseconds). It should be appreciated that other types of computing resource distribution and configuration in a cloud environment can be used within the scope of the technology described herein.

Cloud computing environment 108 also comprises a plurality of disk drives 116a-116n (collectively, 116)—one or more of which are coupled to the database instances 110a, 110b of VMs 108a, 108b. Disk drives 116a-116n comprise physical disk drives (e.g., hard disk drives (HDD) and/or solid-state drives (SSD)) that are used by virtual machines 108a, 108b to store data elements associated with database instances 110a,110b. In the example of a cloud computing environment, these disk drives 116a-116n can be managed/shared disks used by a plurality of different resources or computing devices. Typically, a database instance 110a, 110b is attached to a particular disk drive 116a when initialized and is detached from the disk drive when the entire database management platform and/or one of the VMs 108a, 108b is removed, updated, re-initialized, or rehydrated.

As can be appreciated, system 100 of FIG. 1 can advantageously implement a number of automated workflows and processes to provision virtual machines 108a, 108b and the corresponding elements 110a-110b, 112, 114a-114b in a cloud computing environment 108, instead of relying on manually-invoked jobs and user-based monitoring and intervention to dynamically allocate the computing resources, infrastructure, and security requirements needed to instantiate virtual machines 108a, 108b and the corresponding elements 110a-110b, 112, 114a-114b within the cloud environment 108.

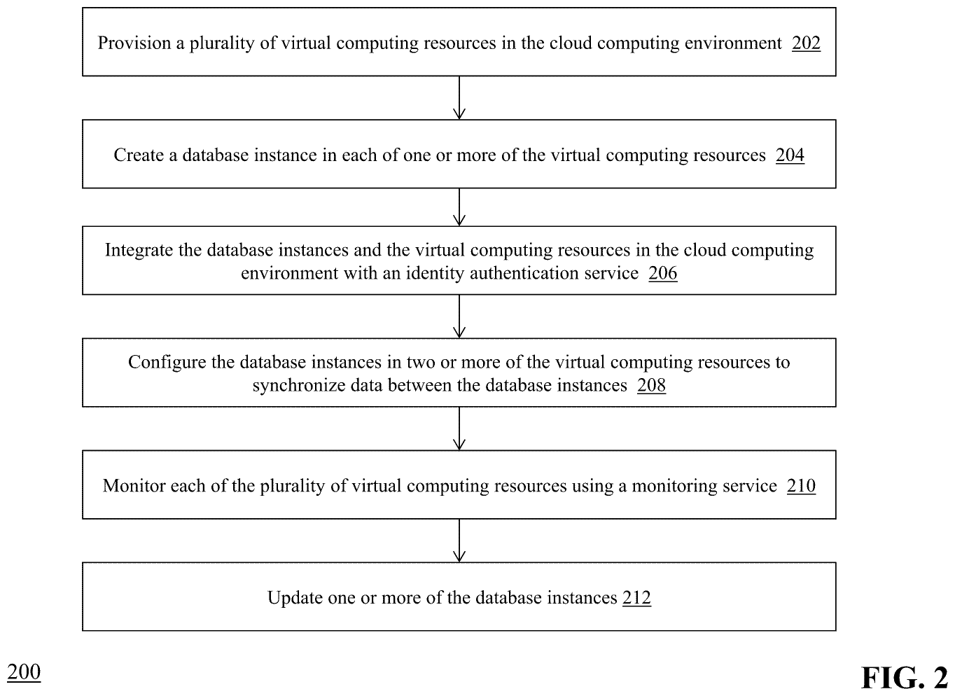

FIG. 2 is a flow diagram of a computerized method 200 of provisioning a database management platform in a cloud computing environment, using system 100 of FIG. 1. In one example, a user at client computing device 102 establishes a connection to server computing device 106 via network 104 to initiate deployment of a new database management platform and/or rehydrate an existing database management platform in cloud computing environment. In some embodiments, the user at client computing device 102 launches a deployment orchestration tool that is either installed on client computing device 102 or made available by server computing device 106. For example, the user at client computing device 102 can open browser software and enter an address (e.g., URL) that points to a web-based interface provided by server computing device 106. The web-based interface can receive a request from client computing device 102 via the URL and respond with a graphical user interface (e.g., webpage) that is presented on client computing device 102 which enables the user to initiate deployment and/or reconfiguration of a database management platform in cloud computing environment 108. In one embodiment, provisioning module 106a determines a role of the user at client computing device 102 (e.g., using authentication credentials and/or a user profile provided by the client computing device) and enables user access to provisioning and deployment of software features (e.g., code files, binaries, libraries, etc.) that, when executed, configure the database management platform in cloud environment 108. Using the deployment orchestration tool, the user can initiate one or more deployment automation pipeline workflows to be used in deploying the database management platform. Exemplary deployment orchestration tools include but are not limited to DevOps automation tools, such as Jenkins™ (available at www.jenkins.io) and/or UrbanCode Deploy™ (uDeploy) (available at www.urbancode.com/product/deploy), which enable the user to build, test, and execute a code base that deploys a database management platform to cloud environment 108.

In some embodiments, the code base includes one or more templates which enable the provisioning and automatic deployment of a database management platform to cloud computing environment 108, including identification of multiple objects, services, instances (and their dependencies)—i.e., DB instances 110a, 110b, observer instance 112, and platform monitor agents 114a, 114b—for the database management platform. The template(s) can be used each time a database management platform is deployed in cloud environment 108. The template(s) can be preconfigured in cloud environment 108 to provide specific computing resources, memory allocations, deployment instructions, configuration settings, and so forth. In some embodiments, provisioning module 106a can provision the database management platform using the template(s) in conjunction with one or more application images retrieved from, e.g., a local or remote image repository. In some embodiments, the code base used to deploy the database management platform is part of a continuous integration/continuous delivery (CI/CD) process, in which changes, updates, and improvements are continuously made to the code base—which can be frequently executed to re-configure and enhance the deployed database management platform in the cloud environment. As mentioned above, deployment of the database management platform includes the provisioning of the underlying elements in the platform—such as DB instances 110a, 110b, observer instance 112, and platform monitor agents 114a, 114b with corresponding VMs 108a, 108b.

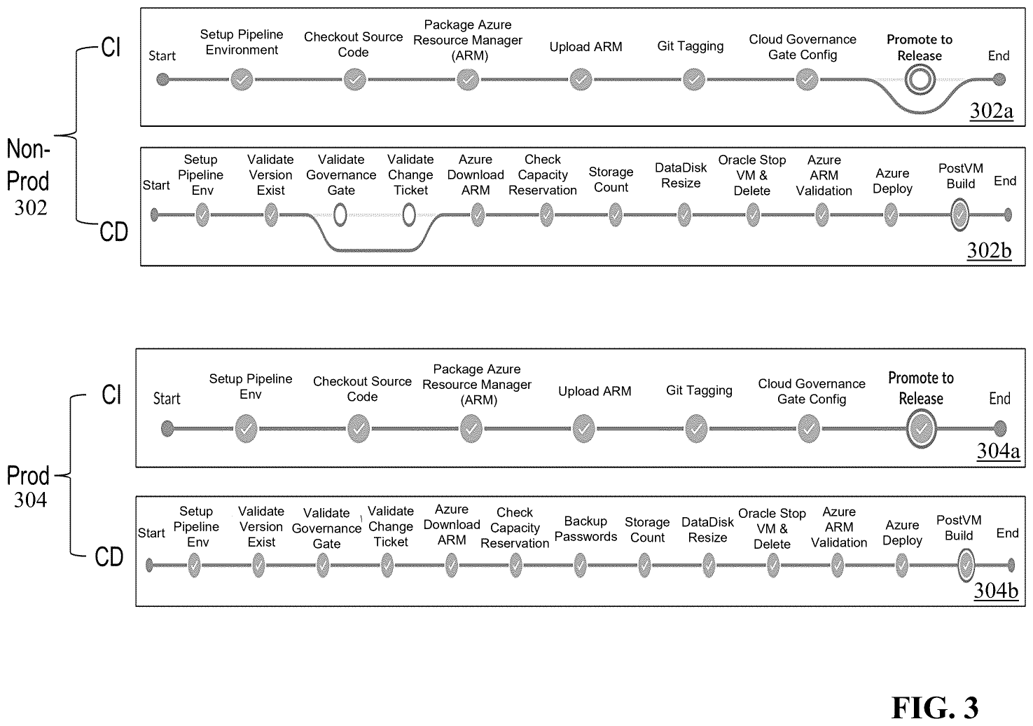

FIG. 3 is a diagram of exemplary deployment automation pipeline workflows that can be executed by provisioning module 106a to deploy the database management platform—including the associated VMs 108a-108b, DB instances 110a-110b, observer instance 112, and platform monitor agents 114a-114b—to cloud computing environment 108. FIG. 3 depicts two pipeline workflows for deployment of a database management platform (such as Oracle® Database) in the Microsoft® Azure™ cloud environment: a non-production environment workflow 302 and a production environment workflow 304. Each of the workflows 302, 304 includes two phases: a continuous integration (CI) phase (302a, 304a respectively) and a continuous deployment (CD) phase (302b, 304b respectively). The continuous integration phase 302a, 304a includes process steps for preparing, packaging, and promoting the source code to be used as part of the database management platform deployed to cloud environment 108. The continuous deployment phase 302b, 304b includes process steps for reserving cloud environment resources (such as VMs 108a, 108b), validating the packaged source code, and configuring and deploying the database management platform in cloud environment 108. As can be appreciated, the CI and CD phases in the non-production workflow 302 differ slightly from the CI and CD phases in the production workflow 304. For example, in the CI phase 302a of the non-production workflow 302, provisioning module 106a does not execute the ‘promote to release’ step-because this workflow is not intended to deploy code to production, the code does not need to be promoted to a release version in the source code management system. In contrast, in the CI phase 304a of the production workflow 304, provisioning module 106a executes the ‘promote to release’ step because the packaged code is intended for release to the production environment.

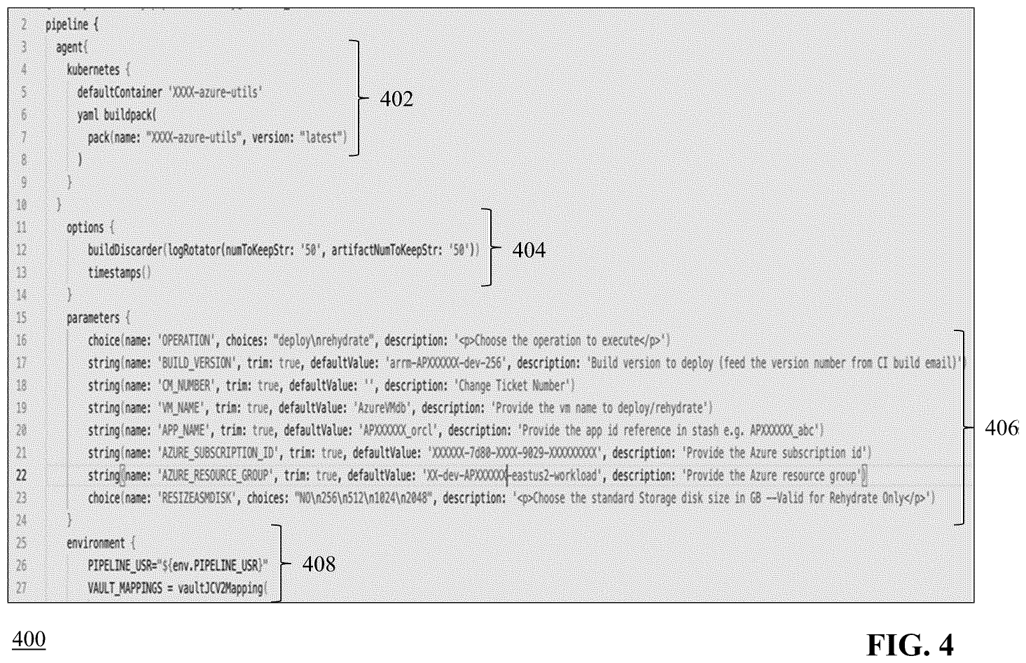

In the CD phase 302b of the non-production workflow 302, provisioning module 106a does not execute the ‘validate governance gate’ and ‘validate change ticket’ steps—because these steps are not required for deployment of code to a non-production environment. However, in the CD phase 304b of the production workflow 304, provisioning module 106a executes the ‘validate governance gate’ and ‘validate change ticket’ steps to ensure that the code meets all organizational and development requirements before it is deployed to the production environment. The CD phase 304b also includes the step of ‘backup passwords’ which is not part of the CD phase 302b in the non-production workflow 302. In some embodiments, the workflows are each defined in a script that comprises a plurality of instructions, commands, and/or references that are used by provisioning module 106a for deployment of the database management platform. FIG. 4 is a diagram of an exemplary workflow script 400 that can be executed by provisioning module 106a for deployment of a database management platform in cloud computing environment 108. As shown in FIG. 4, the script 400 includes sections for build options 424, deployment parameters 406, and pipeline environment 408.

Upon completion of the continuous integration phase of the deployment workflow, provisioning module 106a initiates execution of the continuous deployment phase of the workflow—which includes code validation, capacity reservation, and deployment of the packaged code to cloud computing environment 108. Provisioning module 106a of server computing device 106 reserves (step 202) a plurality of virtual computing resources in a cloud computing environment (i.e., environment 108). As described above, each database management platform that is deployed to cloud computing environment 108 utilizes physical resources such as CPU cores and memory of server computing devices in the environment. As can be appreciated, the cost to use many commercially available cloud computing platforms depends upon the data storage space, virtual machine (VM) size, processor usage, memory resources, and other capacity requirements imposed by the applications and/or functionality that the end user wishes to deploy in the cloud environment. To ensure that the cloud computing environment 108 has sufficient capacity for hosting and execution of the database management platform in a configuration requested by an end user, provisioning module 106a connects to cloud computing environment 108 (e.g., via an application programming interface (API)) and issues one or more requests to reserve resource capacity (e.g., specifying information such as VM size, region, and quantity of instances to be reserved) in the cloud environment prior to deployment of a new database management platform and/or updating/rehydrating an already deployed platform. In some embodiments, upon connecting to cloud computing environment 108, provisioning module 106a authenticates to environment 108 using specified authentication credentials associated with, e.g., a user of client computing device 102 and/or an organization that has an account with the corresponding cloud provider. As can be appreciated, cloud computing environment 108 can respond to the capacity reservation request with an acceptance (indicating that the cloud environment has sufficient capacity available to successfully deploy the database management platform using the criteria specified in the request) or a failure (indicating that the cloud environment does not have capacity available that meets the request). For example, a capacity reservation could fail if the account does not have an adequate subscription quota for the requested VM size, location, or zone combination.

After reserving the virtual computing resources, provisioning module 106a provisions (step 204) a database management platform in cloud computing environment 108 using the reserved virtual computing resources (i.e., VMs 108a, 108b). As one example, provisioning module 106a continues with the CD pipeline workflow and transmits instructions to cloud computing environment 108 to create a virtual computing resource (e.g., VM 108a, 108b) in one or more regions with a configuration that matches the reservation. In some embodiments, provisioning module 106a includes a reference to the reservation (e.g., a reservation ID) in the instructions so that cloud computing environment 108 can associate the VM 108a, 108b with the reservation.

Provisioning module 106a deploys database management platform to one or more virtual computing resources (i.e., VMs 108a, 108b) associated with the reservation. As described above, database management platforms include (i) a primary database instance 110a provisioned in a first region (Region One), (ii) a secondary database instance 110b provisioned in a second region; (iii) a database observer instance 112 provisioned in the first region coupled to the primary database instance 110a and the secondary database instance 110b; and (iv) a platform monitor agent 114a, 114b provisioned in each of the first region and the second region, including attaching the primary database instance 110a and the secondary database instance 110b to one or more physical disk drives 116. In some embodiments, the VMs 108a, 108b used to deploy the database management platform are newly created and provisioning module 106a does not need to modify or delete any existing infrastructure in cloud computing environment 108 to accommodate the database management platform. In some embodiments, provisioning module 106a is modifying an existing database management platform (e.g., updating a version of one or more components of the platform and/or rehydrating one or more elements of the platform). In these embodiments, provisioning module 106a can delete one or more existing infrastructure components (e.g., VMs, instances) in order to complete the modification.

Generally, the deployment of the database management platform can include actions such as installing, configuring, and validating the database instances 110a, 110b in the corresponding VMs 108a, 108b; installing and configuring the platform monitoring agents 114a, 114b in the corresponding regions; and installing the observer instance 112. As mentioned previously, provisioning module 106a uses the pipeline workflow script to execute each step of the deployment using the packaged source code identified in the script.

As shown in FIG. 1, DB instance 110a is configured as the primary instance and DB instance 110b is configured as the secondary (or backup) instance. In some embodiments, secondary DB instance 110b is configured as a replica of primary DB instance 110a in order to provide failover and fault tolerance in the event of a failure in instance 110a—e.g., if DB instance 110a and/or the underlying VM 108a fails or is otherwise experiencing technical issues, system 100 can route data requests to secondary DB instance 110b to ensure uninterrupted service for end users. In some embodiments, system 100 further includes a replication agent provisioned in the VM 108a of the primary database instance 110a that is configured to detect changes to data in the primary database instance 110a and replicate the changes in the secondary database instance 110b. For example, as users interact with data in the primary database instance 110a, the users can add new data, update and/or delete existing data. In order to seamlessly captures these data changes in secondary database instance 110b, the replication agent continuously (or periodically) transmits instructions to secondary database instance 110b to make the corresponding data changes in that instance. As can be appreciated, in some embodiments the functions of the replication agent can be deployed as part of the primary database instance 110a.

In some embodiments, provisioning module 106a connects primary DB instance 110a and secondary DB instance 110b to one or more disk drives 116. In some embodiments, provisioning module connects to each of the VMs 108a, 108b and creates a database instance (i.e., instances 110a, 110b) using, e.g., a database image retrieved from a local or remote image repository. For example, provisioning module 106a can retrieve a database image and deploy the database image into a VM. The database image can be a default database image used in the cloud environment 108 or a customized database image (either newly created for use in the cloud environment 108, uploaded from the server computing device 106, or selected from a network repository). In one example, the database image can be a database-specific Linux™ image that corresponds to a particular database version. In another example, the database image can be a non-database specific Linux image and/or a custom image. As part of creating the database instances, provisioning module 106a attaches one or more storage disks (e.g., disk drives 116) to each of the database instances 110a, 110b for use as physical storage locations for the database instances. During database instance creation, provisioning module 106a can connect to the disk drives 116, determine characteristics like storage capacity, latency, bandwidth, availability, and the like for each disk drive, and select one or more disk drives/locations to attach to each database instance.

Once the database management platform is provisioned, provisioning module 106a configures (step 206) the database observer instance 112 to monitor availability of the primary database instance 110a and to route traffic to the secondary database instance 110b upon detecting that the primary database instance 110a is unavailable. As shown in FIG. 1, observer instance 112 is deployed in VM 108a of Region One and is coupled to each of primary DB instance 110a and secondary DB instance 110b. However, in some embodiments observer instance 112 can be deployed in VM 108b of Region Two, a different VM in Region One or Region Two, or a VM in a different region (Region Three (not shown)). Observer instance 112 monitors messages and calls generated by primary DB instance 110a to determine whether instance 110a is online/operating within accepted performance targets (e.g., bandwidth, latency, transaction speed); or whether the instance 110a is offline/experiencing errors or corruption that would require failover to another instance (i.e., secondary DB instance 110b). In some embodiments, when observer instance 112 identifies a condition in DB instance 110a that triggers the failover process (e.g., offline, corrupted file, inaccessible log file, or other failure condition), observer instance 112 stops primary DB instance 110a from receiving any further requests by routing requests intended for instance 110a to secondary DB instance 110b. Observer instance 112 can continue to monitor primary DB instance 110a and reverse the failover upon detecting that primary instance 110a has resumed normal operation.

Continuing with FIG. 2, provisioning module 106a integrates (step 306) the deployed database management platform (i.e., resources 110a-110b, 112, and 114a-114b) in the cloud environment 108 with identity authentication service 106b of server computing device 106. For example, in some infrastructures, server computing device 106 can maintain an on-premises user access management module such as identity authentication service 106b. To ensure seamlessness and uniformity of access control from on-premises to cloud, it is desirable to synchronize user accounts between the local identity authentication service 106b and the cloud environment 108. This also enables users to access DB instances 110a, 110b according to the specific permissions/roles assigned to them in the on-premises system. In some embodiments, identity authentication service 106b is configured to connect to the cloud environment 108 and establish a link relationship between a user of the identity authentication service 106b and a corresponding cloud representation of the user (that is maintained by the cloud service provider). The configuration of the cloud environment 108 enables each of the components of the database management platform to access the user access information when responding to requests (e.g., data read/write/update requests, application execution, etc.) that require access to data (e.g., via disk drives 116). Then, when access changes are made to the users in identity authentication service 106b, those changes are synchronized automatically to the cloud environment 108.

As can be appreciated, a benefit of implementing resources and services in a cloud computing environment is the ability to create redundancy and failover infrastructures so that critical enterprise data pipelines and applications do not experience any interruptions in service. During initial deployment and/or during subsequent updates, provisioning module 106a can configure the cloud environment 108 (including VMS 108a, 108b and corresponding elements 110a-110b, 112, and 114a-114b) according to any of a number of different high availability patterns so that data processing features and pipelines remain consistent and able to be accessed across different platforms and/or regions in cloud computing environment 108.

In one example, VM 108a may experience an error or technical problem that prevents normal operation (e.g., failure of cloud hardware, network connectivity issues, etc.). In such events, it is crucial to seamlessly swap from VM 108a in one region to another VM 108b (also called site switching) in a different region so that system operation and availability is not affected. In some embodiments, the site switching process includes the requirement to disable a first database instance (e.g., 110a) in the VM that is experiencing problems and enable corresponding database instance(s) (e.g., 110b) in another VM.

As can be appreciated, such high availability patterns provide several technical advantages to the overall system 100. Once a high availability pattern is set up, monitoring service 106c of server computing device 106 connects to each of the platform monitor agents 114a, 114b deployed in cloud environment 108 to monitor (step 210 of FIG. 2) each of the corresponding VMs 108a, 108b. For example, monitoring service 106c can actively track characteristics of the database management platform, including the VMs 108a, 108b and their associated computing resources in cloud computing environment 108, such as functional status, memory load, data errors, network connectivity, bandwidth, processing overhead, usage, data processing requests, online/offline status, and the like. In some embodiments, monitoring service 106c can receive one or more log files generated by platform monitor agents 114a, 114b and analyze the log files to determine the above characteristics as part of the monitoring process.

In some embodiments, each region of the cloud computing environment 108 can include an event manager agent provisioned to capture usage and performance metrics for the primary database instance 110a and the secondary database instance 110b, respectively. Each event manager agent can be coupled to monitoring service 106c for transmission of the usage and performance metrics to monitoring service 106 for analysis. For example, the event manager agent can capture data relating to, e.g., user connections, transaction load (e.g., reads/writes), data errors, transaction latency, and other types of database statistics. In some embodiments, the functions of the event manager agent can be combined with the platform monitor agent 114a, 114b that is deployed in the corresponding VM.

Upon detecting an undesirable or adverse condition of one or more of the VMs 108a, 108b (such as a computing resource failure) and/or the database instances 110a, 110b (such as a data read/write error), monitoring service 106c can redirect traffic from the failing VM 108a in one region to another VM 108b in another region in order to maintain continuity of data processing availability and system functionality. In some embodiments, monitoring service 106c can additionally transmit alert messages received from one or more of platform monitor agents 114a, 114b via an established connection when a failure event occurs at the associated VMs 108a, 108b. The alert message can be transmitted to, e.g., an end user device such as client computing device 102 so that system administrators and other personnel can be informed of the service interruption. Alert messages can also be generated and transmitted by monitoring service 106c in the event that failures or errors are detected at one or more disk drives 116 and/or other system resources that are connected to cloud environment 108.

In addition to the above features, the systems and methods described herein provide for seamless updating of the elements 110a-110b, 112, and 114a-114b of the database management platform through a process of rehydration. As can be appreciated, existing deployed database management systems may require periodic or emergency software image updates (e.g., when configuration updates are required, when a new database or supporting software version and/or operating system version is released, when a data resource is changed, when a new security patch is released, etc.). Rehydration service 106d can be configured to initiate a rehydration process to refresh (step 212 of FIG. 2) one or more of the reserved virtual computing resources in the database management platform in cloud computing environment 108.

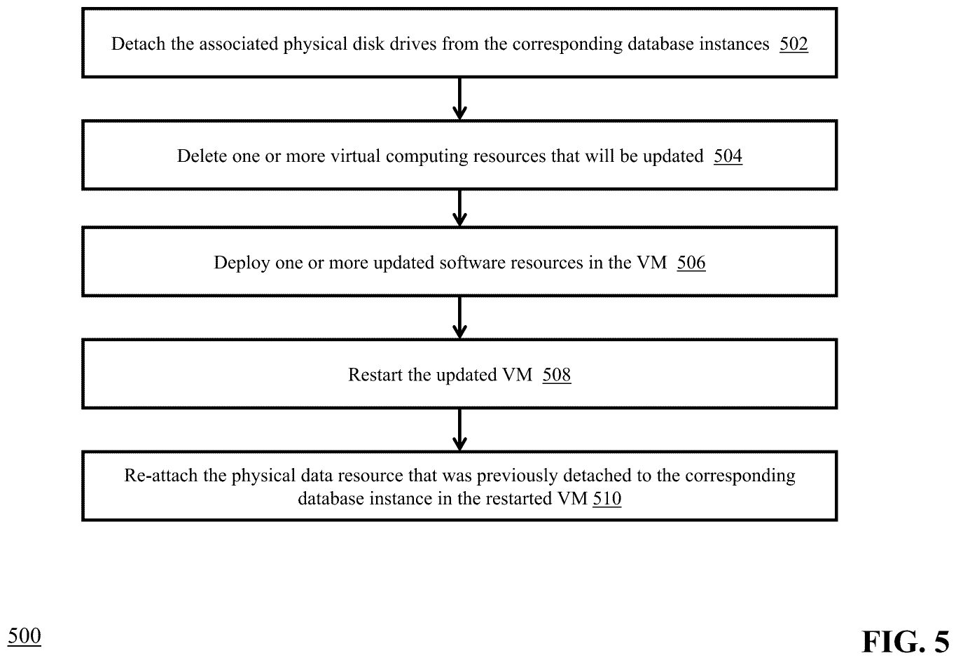

FIG. 5 is a flow diagram of a computerized method 500 of refreshing a VM 108a, 108b and associated elements 110a-110b, 112, and/or 114a-114b in cloud computing environment 108 via rehydration. In some embodiments, the user at client computing device 102 can interact with rehydration service 106d to initiate the rehydration process. In other embodiments, rehydration service 106d periodically analyzes the software and resources utilized in each VM 108a, 108b in the database management platform and determines when to initiate rehydration (e.g., a new software version, database version, or OS version is released; a security patch is ready for implementation, etc.).

Rehydration service 106d detects that one or more of VMs 108a, 108b and/or one or more virtual computing resources within the VMs 108a, 108b needs to be updated. For example, when a new version of software associated with the database management platform is released, provisioning module 106c can be configured to determine that the current version of the operating system software deployed in VMs 108a, 108b is out of date (e.g., by comparing a build number, version number, or other similar indicia). In another example, rehydration service 106d can be configured to determine that a code base associated with database management platform has been modified (e.g., via a build instruction or other indicia from a code development management system and/or issue tracking ticket system). A common rehydration process is to update software associated with VMs 108a, 108b periodically to ensure the latest patches and functionality is contained in the VMs 108a, 108b.

To begin the rehydration process, rehydration service 106d detaches (step 502) the physical disk drive 116a-116n from the corresponding database instance 110a, 110b in the VM 108a, 108b that is being refreshed. Next, rehydration service 106d deletes (step 504) one or more virtual computing resource(s) (e.g., software modules, linked services, libraries, OS components) in the VM 108a, 108b that will be updated via rehydration. In some embodiments, rehydration service 106d can stop/remove the entire VM 108a, 108b from cloud computing environment 108 and deploy a new VM (with updated software) using the same computing resources that were allocated for the VM that was removed.

Rehydration service 106d then deploys (step 506) one or more updated software resources in the corresponding VM 108a, 108b. In some embodiments, rehydration service 106d uses updated resource templates (i.e., newer or changed templates that are different from those originally used to create the VMs 108a, 108b). For example, rehydration service 106d can deploy the new software or services in the VM 108a, 108b using an updated software image file (e.g., an operating system image file or a security patch image file) that was created to deploy the new version of the software and/or virtual computing resource(s) in cloud environment 108. After the new virtual computing resource is created in VM 108a, 108b, rehydration service 106d restarts (step 508) the updated VM 108a, 108b. After rehydration is complete, rehydration service 106d re-attaches the physical data resources (i.e., disk drives 116 that were previously detached) to the corresponding database instance 110a, 110b in the restarted VM 108a, 108b.

Upon deploying a database management platform, provisioning module 106a can validate the deployment to confirm that all components of the database management platform are installed and functioning correctly in the cloud computing environment 108. In some embodiments, the deployment pipeline script executed by provisioning module 106a includes one or more validation steps-whereby module 106a issues requests to cloud computing environment 108 (including but not limited to VMS 108a, 108b and/or the associated elements 110a-110b, 112, 114a-114b) to confirm that the database management platform is operating as expected. In some embodiments, provisioning module 106a can compile and transmit a validation report to a remote computing device (e.g., client computing device 102) that includes deployment details and information on the results of the deployment validation.

As mentioned above, system 100 can implement any or all of the techniques described herein using an automated, script-based approach. For example, provisioning module 106a can be configured to store one or more scripts (see FIG. 4) that comprise a series of instructions to automatically carry out the required steps for the functions described in FIGS. 2, 3, and 5. For example, a user at client computing device 102 can connect to server computing device 106 and initiate execution of one or more scripts to create data orchestration platforms and corresponding virtual computing resource infrastructure, configure the high availability patterns described herein according to specified requirements, enable the synchronization of data across regions, resources and instances, integrate the cloud computing environment with the identity authentication service, and perform rehydration of resources and/or instances in the cloud environment in order to update relevant software. In this way, the methods and systems advantageously provide for the automated provisioning and management of data orchestration platforms in a cloud computing environment to overcome the lack of existing tools to accomplish such deployment.

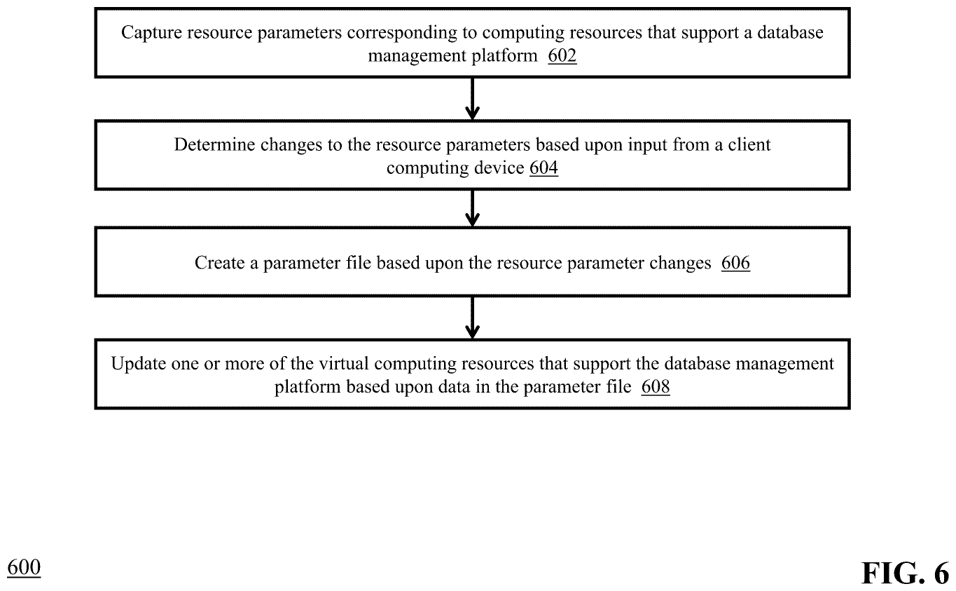

The systems and methods described herein also provide the technical improvement of implementing an automated persistent update pipeline to handle large-scale changes to the computing resources that support the database management platform as deployed in the cloud computing environment. FIG. 6 is a flow diagram of a computerized method 600 for capturing changes to resource parameter values for computing resources supporting a database management platform in a cloud computing environment, using system 100 of FIG. 1. As can be appreciated, the method 600 can be implemented in system 100 as part of a persistent update pipeline that is executed by one or more modules of server computing device 106. Generally, and without limitation, the persistent update pipeline can comprise a logical series of computing tasks that can be performed by server computing device 106 to modify one or more aspects of the particular deployment of database management platforms 108a-108b in cloud computing environment. It should be understood that in some embodiments server computing device 106 can perform all of the computing tasks that make up the persistent update pipeline, and in some embodiments server computing device 106 can perform a portion of the computing tasks in the persistent update pipeline.

Provisioning module 106a captures (step 602) a plurality of resource parameters corresponding to one or more computing resources deployed in the cloud computing environment to support a database management platform. In some embodiments, monitoring service 106c of server computing device 106 connects to cloud computing environment 108 to analyze performance of physical and/or logical computing resources (e.g., VMs, memory, processor(s), disk drive(s)) contained in the environment 108 as the database management platforms 108a-108b are used and accessed by client devices 102. For example, monitoring service 106c can receive resource performance data from cloud computing environment 108 including CPU usage, memory usage, disk drive usage, network bandwidth and transfer rate, among others. Monitoring service 106c can also capture certain configuration attributes of the database management platform 108a, 108b that is deployed to the cloud environment 108, such as identity of disk group(s) to which disk drives 116 are assigned in specific platform(s) 108a, 108b, size of disk group(s), throughput of disk group(s), input/output operations per second (IOPS) of disk group(s), number of volumes in disk group(s), and identity and configuration of security group(s) that handle traffic between the database management platform 108a, 108b and the disk drives 116. Monitoring service 106c can transmit the resource performance data and/or configuration attributes captured from the cloud computing environment 108 to provisioning module 106a.

Provisioning module 106a determines (step 604) one or more changes to the resource parameters based upon input from client computing device 102. In some embodiments, a system administrator or other support personnel may want to modify the computing resource configuration that supports one or more database management platforms 108a-108b deployed in cloud computing environment 108. In one example, the computing resources that support the database management platforms 108a-108b can be scaled up to support more connections or access requests for the corresponding DB instances 110a-110b. Provisioning module 106a can present the captured resource parameters to a user at client computing device 102 (e.g., via a graphical user interface), and the user can provide input comprising one or more changes to the captured resource parameters. For example, the user may change the number of disk group volumes or the size of the disk group for one or more of the database management platforms 108a-108b. The user can submit the proposed resource parameter changes to provisioning module 108a by, e.g., interacting with the user interface.

Provisioning module 106a creates (step 606) a parameter file based upon the resource parameter changes received from client computing device 102. The parameter file comprises an identification of each of the resource parameters (e.g., parameter name, parameter identifier) along with a corresponding parameter value which represents the proposed changes to the parameter as received from client computing device 102. For example, the database management platform 108a-108b currently provisioned in cloud computing environment 108 may comprise two disk group volumes. The user at client computing device 102 can decide to add one new volume to the disk group for a database management platform 108a-108b. As a result, the parameter file can include data relating to the resource parameter (e.g., ADD_VOLUME_DG) and a corresponding new parameter value (e.g., three). In some embodiments, the parameter file can indicate the current parameter value as well as the proposed new parameter value. In some embodiments, the parameter file can indicate the change proposed for the parameter value (e.g., +1).

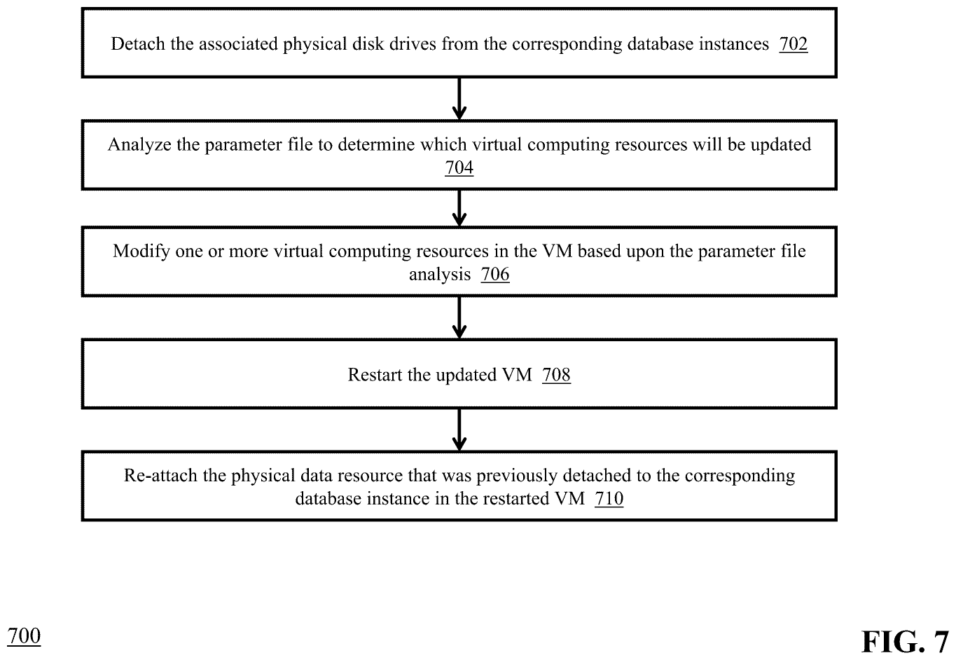

Once the parameter file has been created, provisioning module 106a updates (step 608) one or more of the virtual computing resources in cloud computing environment 108 using the data stored in the parameter file. In some embodiments, provisioning module 106a can update the virtual computing resources using a process similar to that as described above with respect to FIG. 5. FIG. 7 is a flow diagram of a computerized method 700 of updating the computing resources supporting a database management platform 108a, 108b and associated elements 110a-110b, 112, and/or 114a-114b in cloud computing environment 108 based upon changed resource parameter values. As can be appreciated, the method 700 can be implemented in system 100 as part of the persistent update pipeline described above with respect to FIG. 6. 106a As shown in FIG. 7, provisioning module 106a detaches (step 702) the physical disk drive 116a-116n from the corresponding database instance 110a, 110b in the VM 108a, 108b that is being updated. Next, provisioning module 106a analyzes (step 704) the parameter file to determine which computing resource(s) will be updated. In some embodiments, provisioning module 106a scans the parameter file and detects the resource parameter values that represent changes to the current resource configuration.

Based upon the file analysis, provisioning module 106a modifies (step 706) one or more virtual computing resource(s) in the VM 108a, 108b that is being updated. For example, when the parameter file indicates that one or more disk group volumes are being removed from the VM, provisioning module 106a can execute an update pipeline that verifies the type of disk group deletion (e.g., deleting an EBS volume from AWS, dropping a disk from an Oracle ASM disk group) and performs the corresponding action. Once the disk group volume is removed, provisioning module 106a can execute a portion of the persistent update pipeline that deletes the corresponding computing resources for the disk group volume and updates the VM 108a, 108b. Similarly, when the parameter file indicates that one or more disk group volumes are being added to the VM, provisioning module 106a can execute another portion of the persistent update pipeline that comprises computing tasks to (i) add the desired number of disk group volumes, (ii) provision corresponding computing resources for the added disk group volumes, and (iii) update the VM 108a, 108b.

In some embodiments, provisioning module 106a can stop/remove the entire VM 108a, 108b from cloud computing environment 108 and deploy a new VM with the updated resource configuration. In some embodiments, provisioning module 106a can make the desired resource changes to existing computing resources without requiring removal of the entire VM 108a, 108b. In some embodiments, provisioning module 106a uses updated resource templates (i.e., newer or changed templates that are different from those originally used to create the VMs 108a, 108b). For example, provisioning module 106a can deploy the new software or services in the VM 108a, 108b using an updated software image file (e.g., an operating system image file or a security patch image file) that was created to deploy the new version of the software and/or virtual computing resource(s) in cloud environment 108. After the new virtual computing resource is created in VM 108a, 108b, provisioning module 106a restarts (708) the updated VM 108a, 108b. After the update is complete, provisioning module 106a re-attaches (710) the physical data resources (i.e., disk drives 116 that were previously detached) to the corresponding database instance 110a, 110b in the restarted VM 108a, 108b.

Upon executing the persistent update pipeline to modify one or more of the VMs 108a, 108b in cloud computing environment 108, provisioning module 106a can validate the updates to the computing resources in the deployment to confirm that all components of the database management platform are installed and functioning correctly in the cloud computing environment 108. In some embodiments, the persistent update pipeline script executed by provisioning module 106a includes one or more validation steps—whereby module 106a issues requests to cloud computing environment 108 (including but not limited to VMS 108a, 108b and/or the associated elements 110a-110b, 112, 114a-114b) to confirm that the database management platform is operating as expected. In some embodiments, provisioning module 106a can compile and transmit a validation report to a remote computing device (e.g., client computing device 102) that includes deployment details and information on the results of the deployment validation.

As can be appreciated, the validation steps can be performed in parallel with provisioning of the computing resources in the VMs 108a, 108b as part of the persistent update pipeline execution. As one example, provisioning module 106a can keep track of errors during database setup (e.g., by examining a deployment log file to identify errors that have a defined prefix—such as ORA-*—that indicate the error corresponds to database deployment. If such errors are found in the log file, provisioning module 106a can automatically stop deployment and transmit an electronic communication (e.g., alert, email) to an end user. The electronic communication can include an identification of the detected errors and instruct the end user to review the deployment structure and pipeline before starting a new infrastructure setup.

Other functions that can be included in the persistent update pipeline include, but are not limited to:
A function to check a list of mandatory tags on VM host and/or related infrastructure for reporting;
A function that enables the DevOps team or database administrator to clone an entire set of deployment pipeline scripts from a given code repository (e.g., Git repository or branch) onto the cloud environment host where the computing resources will be deployed; and
A function to create a disaster recovery (DR) database for a given primary database in one or more different cloud platforms (e.g., AWS, Azure).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—allowing access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and to store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random- access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for updating computing resources deployed in database management platforms in a cloud computing environment, the system comprising a server computing device having a memory for storing computer-executable instructions and a processor that executes the computer-executable instructions to:
capture a plurality of resource parameters corresponding to one or more virtual computing resources that support a database management platform deployed in a cloud computing environment coupled to the server computing device, the cloud computing environment comprising a plurality of regions;
determine one or more changes to the resource parameters based upon input from a client computing device coupled to the server computing device;
create a parameter file based upon the determined changes to the resource parameters; and
update one or more of the virtual computing resources that support the database management platform in the cloud computing environment using data stored in the parameter file, including:
deleting a first one or more of a plurality of existing disk group volumes associated with a primary database instance provisioned in a first region and a secondary database instance provisioned in a second region,
resizing a second one or more of the plurality of existing disk group volumes associated with the primary database instance and the secondary database instance,
adding one or more new disk group volumes associated with the primary database instance and the secondary database instance, and
modifying one or more of a size, a throughput, a volume type, and a number of input/output operations per second of at least one of the disk group volumes currently available in the database management platform.

2. The system of claim 1, wherein a monitoring service provided by the server computing device captures the resource parameters by analyzing computing performance metrics and configuration attributes of the database management platform.

3. The system of claim 1, wherein determining one or more changes to the resource parameters based upon input from the client computing device comprises:
comparing a resource parameter value captured by the server computing device to a corresponding resource parameter value contained in the input from the client computing device; and
determining a difference between the resource parameter value captured by the server computing device and the corresponding resource parameter value contained in the input.

4. The system of claim 3, wherein the server computing device modifies the resource parameter value captured by the server computing device to match the corresponding resource parameter value contained in the input.

5. The system of claim 4, wherein creating the parameter file based upon the determined changes to the resource parameters comprises storing the modified resource parameter value in the parameter file and associating the modified resource parameter value with an identifier for the resource parameter.

6. The system of claim 1, wherein the database management platform further comprises a database observer instance provisioned in the first region coupled to the primary database instance and the secondary database instance.

7. The system of claim 6, wherein the database observer instance monitors availability of the primary database instance and to route traffic to the secondary database instance upon detecting that the primary database instance is unavailable.

8. The system of claim 1, wherein an identity authentication service provided by the server computing device establishes a connection between the database management platform and the server computing device and couples the primary database instance and the secondary database instance to the identity authentication service such that authentication of requests to access the database instances is performed by the identity authentication service.

9. The system of claim 1, wherein the server computing device executes a persistent update pipeline script to initiate capturing the plurality of resource parameters, determining changes to the resource parameters, creating the parameter file, and updating the virtual computing resources that support the database management platform.

10. The system of claim 1, wherein updating one or more of the virtual computing resources that support the database management platform in the cloud computing environment using data stored in the parameter file comprises deleting one or more of the virtual computing resources and provisioning one or more new virtual computing resources in the database management platform using updated resource templates.

11. The system of claim 10, wherein the updated resource templates comprise an operating system image file or a security patch image file.

12. The system of claim 1, wherein the server computing device validates the updating of the virtual computing resources that support the database management platform in the cloud computing environment upon completion of the modifying step.

13. The system of claim 1, wherein updating of the virtual computing resources that support the database management platform in the cloud computing environment further comprises modifying one or more security groups configured to control access to disk drives coupled to the database instances of the database management platform.

14. A computerized method of updating computing resources deployed in database management platforms in a cloud computing environment, the method comprising:
capturing, by a server computing device, a plurality of resource parameters corresponding to one or more virtual computing resources that support a database management platform deployed in a cloud computing environment coupled to the server computing device, the cloud computing environment comprising a plurality of regions;
determining, by the server computing device, one or more changes to the resource parameters based upon input from a client computing device coupled to the server computing device;
creating, by the server computing device, a parameter file based upon the determined changes to the resource parameters; and
updating, by the server computing device, one or more of the virtual computing resources that support the database management platform in the cloud computing environment using data stored in the parameter file, including:
deleting a first one or more of a plurality of existing disk group volumes associated with a primary database instance provisioned in a first region and a secondary database instance provisioned in a second region,
resizing a second one or more of the plurality of existing disk group volumes associated with the primary database instance and the secondary database instance,
adding one or more new disk group volumes associated with the primary database instance and the secondary database instance, and
modifying one or more of a size, a throughput, a volume type, and a number of input/output operations per second of at least one of the disk group volumes currently available in the database management platform.

15. The method of claim 14, wherein a monitoring service provided by the server computing device captures the resource parameters by analyzing computing performance metrics and configuration attributes of the database management platform.

16. The method of claim 14, wherein determining one or more changes to the resource parameters based upon input from the client computing device comprises:
comparing a resource parameter value captured by the server computing device to a corresponding resource parameter value contained in the input from the client computing device; and
determining a difference between the resource parameter value captured by the server computing device and the corresponding resource parameter value contained in the input.

17. The method of claim 16, further comprising modifying, by the server computing device, the resource parameter value captured by the server computing device to match the corresponding resource parameter value contained in the input.

18. The method of claim 17, wherein creating the parameter file based upon the determined changes to the resource parameters comprises storing the modified resource parameter value in the parameter file and associating the modified resource parameter value with an identifier for the resource parameter.

19. The method of claim 14, wherein the database management platform further comprises a database observer instance provisioned in the first region coupled to the primary database instance and the secondary database instance.

20. The method of claim 19, wherein the database observer instance monitors availability of the primary database instance and to route traffic to the secondary database instance upon detecting that the primary database instance is unavailable.

21. The method of claim 14, wherein an identity authentication service provided by the server computing device establishes a connection between the database management platform and the server computing device and couples the primary database instance and the secondary database instance to the identity authentication service such that authentication of requests to access the database instances is performed by the identity authentication service.

22. The method of claim 14, further comprising executing, by the server computing device, a persistent update pipeline script to initiate capturing the plurality of resource parameters, determining changes to the resource parameters, creating the parameter file, and updating the virtual computing resources that support the database management platform.

23. The method of claim 14, wherein updating one or more of the virtual computing resources that support the database management platform in the cloud computing environment using data stored in the parameter file comprises deleting one or more of the virtual computing resources and provisioning one or more new virtual computing resources in the database management platform using updated resource templates.

24. The method of claim 23, wherein the updated resource templates comprise an operating system image file or a security patch image file.

25. The method of claim 14, further comprising validating, by the server computing device, the updating of the virtual computing resources that support the database management platform in the cloud computing environment upon completion of the modifying step.

26. The method of claim 14, wherein updating of the virtual computing resources that support the database management platform in the cloud computing environment further comprises modifying one or more security groups configured to control access to disk drives coupled to the database instances of the database management platform.
